(19) United States
(12) Patent Application Publication
(10) Pub. No.: US 2025/0285175 A1
(43) Pub. Date: Sep. 11, 2025

(54) SYSTEMS AND METHODS FOR PROVIDING HOUSING ACCOMODATIONS

(71) Applicant: AC GOLDBERG, Cambridge, MA (US)

(72) Inventor: AC GOLDBERG, Cambridge, MA (US)

(21) Appl. No.: 19/072,708

(22) Filed: Mar. 6, 2025

Related U.S. Application Data
(60) Provisional application No. 63/562,152, filed on Mar. 6, 2024.

(51) Int. Cl. G06Q 30/0645; G06Q 50/16; G06Q 50/26

(52) U.S. Cl. CPC G06Q 30/0645; G06Q 50/16; G06Q 50/265

(57) ABSTRACT

The present disclosure aims to provide housing accommodations based on an applicant's response to prompts regarding the applicant's comfort with rooming with a transgender person. Embodiments of the present disclosure may include a prompt in an online, internet-based housing application that asks whether an applicant is comfortable rooming with a transgender and/or nonbinary person. This method ensures that housing assignments will comply with applicant preferences, and allow for the safe and comfortable housing assignments. It will also reduce the number of gender-related rehousing requests.

This application claims the benefit of U.S. Provisional Patent Application No. 63/562,152, filed Mar. 6, 2024, entitled SYSTEMS AND METHODS FOR PROVIDING HOUSING ACCOMMODATIONS. All of the foregoing application is hereby incorporated by reference as if fully set forth herein in its entirety.

### BACKGROUND OF THE INVENTION

The present disclosure generally relates to providing housing accommodations. In particular, in an embodiment, the present disclosure is directed to providing housing accommodations based on an applicant's response to prompts regarding the applicant's comfort with rooming with a transgender or nonbinary person.

In a college dormitory setting, a student's gender generally plays a role in determining their housing and roommate assignment. In most cases, students are assigned roommates of the same gender. For example, a student with a female gender designation would be assigned to a room with other students with female gender designations, and a student with a male gender designation would be assigned to a room with other students with male gender designations. These policies aim to ensure that student housing is a safe place where students can be themselves, and feel comfortable in their living space. This general practice of gender-based housing assignment is followed in other housing settings where rooms and roommates are assigned, like, for example, at stay-away camps, shelters, and the like.

Gender identity encompasses a broad spectrum that includes more than just the male-female binary. In an effort to accommodate the varied gender identities represented in campus communities, including transgender and nonbinary gender identities, some colleges and universities have what is referred to as gender-inclusive housing where students with a nonbinary or different identity gender designations are assigned to rooms with other students that have nonbinary or different identity gender designations. In some cases, existing housing applications may give students the option to select a preference to be roomed with persons of any gender identity.

These current systems and methods of gender-based housing assignments are inadequate to ensure that students are housed safely and comfortably. However, one problem with current systems is that students have privacy concerns related to direct questions about their gender identity, i.e., self-identifying questions. A person's gender identity can understandably be a very sensitive, private issue that one does not want to share, even on housing applications. Students may have reasonable concerns that the their parents or guardians may see their housing application responses, and expose them. In other cases, applicants may have genuine questions regarding their own gender identity, but they are nevertheless asked to self-identify. An applicant may be at the very start or end of their transition, so they may not feel as though they fall within any of the gender-based categories. For instance, if a trans-female applicant began transitioning early, and has completed or nearly completed her transition by the time she is eighteen years old and entering college or university, she may identify as female and not want to indicate her trans-identity. That is, the goal for some trans individuals is to live as a cisgender person when their transition if complete. The reality is that, students may justifiably not be entirely forthcoming in housing applications that ask self-identifying questions, and may reluctantly fail to self-identify their gender or indicate a willingness to live in all-gender or gender-inclusive housing.

Another issue with current systems relates to scarcity. Most campuses don't have enough gender-inclusive or all-gender housing to meet demand. So, schools have to house trans and nonbinary students with cisgender students. Sometimes problems may arise if roommates are uncomfortable with the gender identity of their roommate. A person's 20) discomfort with their roommate's gender is not inherently wrong; it is however problematic. In such cases, the college or university may have to process a rehousing request, which is a painful, costly, time-consuming, and stressful endeavor. And in the worst case, transgender and nonbinary students may be subjected to prejudice or even violence.

At the end of the day, every student—cisgender, transgender, and nonbinary alike—should feel safe and comfortable with their housing assignment. There remains a need for a system and method to provide housing accommodations for all students to ensure their safety and comfort.

### BRIEF SUMMARY OF THE INVENTION

An object of the present disclosure is to provide housing accommodations based on an applicant's response to prompts regarding the applicant's comfort with rooming with a transgender person. Embodiments of the present disclosure may include a prompt in an online, internet-based housing application that asks whether an applicant is comfortable rooming with a transgender and/or nonbinary person.

In an embodiment, a computer-implemented method for generating a housing application module and data is provided and comprises: (1) receiving a request for a housing application from an applicant; (2) generating a housing application module in response to the request; (3) transmitting the housing application module to the applicant; (4) transmitting a roommate-comfort prompt to the applicant; (5) receiving completed housing application data from the applicant; and (6) prioritizing the roommate-comfort prompt response data over other application data. This method ensures that housing assignments will comply with applicant preferences, and allow for the safe and comfortable housing assignments. It will also reduce the number of gender-related rehousing requests.

The disclosed system and method has the benefit of taking the onus off the applicant and instead focuses the inquiry on the applicant's comfort with a roommate. This resolves many of the problems with current systems at least because schools are able to easily identify cisgender students who are comfortable rooming with trans or nonbinary individuals, and assign appropriate housing accordingly. For example, in response to the prompt, trans applicants will almost certainly answer affirmatively, and cisgender applicants who know they are comfortable rooming with trans and nonbinary people will also answer affirmatively. And cisgender applicants who know they are not comfortable rooming with trans and nonbinary people will understandably answer no. In any event, housing authorities will receive fewer gender-based, re-housing requests because students will be appropriately housed at the outset.

Other aspects and advantages of the present disclosure will become apparent from the following detailed description, taken in conjunction with the accompanying drawings. illustrating the principles of the disclosure by way of example only.

### BRIEF DESCRIPTION OF THE FIGURES

The accompanying drawings, which are incorporated herein as part of this specification illustrate embodiments of the disclosure, and together with the general and detailed descriptions herein provided, serve to explain and illustrate features of the disclosure. References to the following drawings are in no way limiting and are for illustrative purposes only:

FIG. 1 illustrates a prompt of an embodiment of the present disclosure; and

FIG. 2 illustrates a flow chart of an embodiment of the present disclosure.

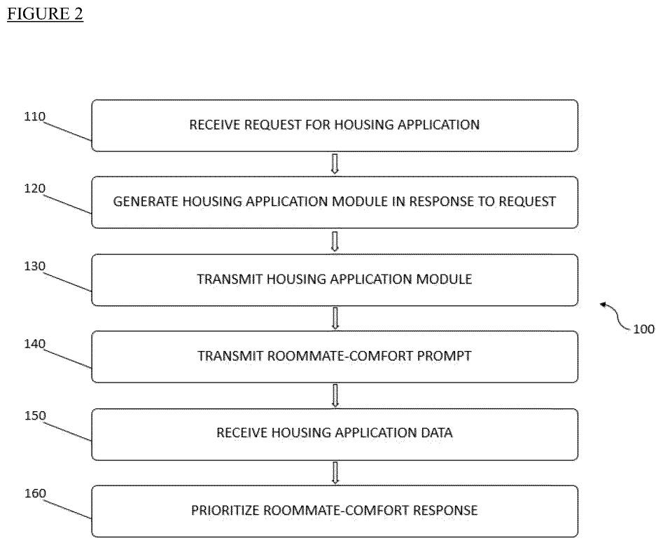

### DETAILED DESCRIPTION OF THE INVENTION

The below disclosure describes systems and methods for providing housing accommodations. In the following description, for the purposes of explanation and illustration, numerous details are set forth so as to provide an explanation of the present disclosure. It will be evident to a person of ordinary skill in the art, however, that the exemplary embodiments disclosed herein are illustrative only and not limiting or restrictive.

In an embodiment of the present disclosure, a system for providing housing assignments comprises a housing server 100. The housing server 100 may include or be a combination of a cloud-computing system, a data center, a server rack, a server, a virtual server, a desktop computer, a laptop computer, a tablet computer, a server device, a client device, or an application program interface (API) running on a mobile phone, a game console, a vehicle-mounted computer, a television or device connected to a television, or the like. The housing server 100 may also be a web browser extension. The housing server 100 may also be connected to other devices that are not illustrated, or may operate as a stand-alone system.

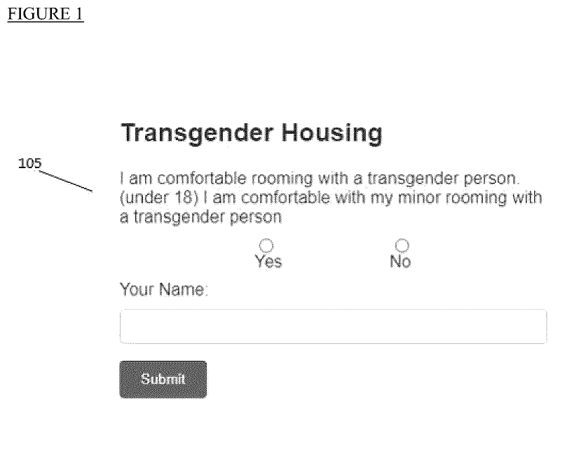

The housing server 100 functions to, among other things, run scripts and store information that provide housing accommodations based on an applicant's response to prompts. Like any housing application, the prompts include a plethora of the applicant's personal information, like name, address, contact information, date of birth, etc. In particular, the prompt in the present disclosure regards whether the applicant is comfortable rooming with a transgender person. For instance, as depicted in FIG. 1, the housing server 100, upon request from for an applicant, transmits a roommate-comfort prompt 105 to the applicant. The roommate-comfort prompt 105 asks the applicant, for example, if the applicant is comfortable rooming with a transgender person. The roommate-comfort prompt 105 may also ask whether the applicant is comfortable rooming with nonbinary persons. It may ask one or both questions relating to transgender and nonbinary persons. In the event that the applicant is a minor, the roommate-comfort prompt 105 may ask for a response from a parent or guardian. This may have applicability at colleges and universities, but also at housing assignments for stay-away camps, shelters, and the like. The present disclosure has utility in a number of different housing accommodations and it not limited to the embodiments disclosed herein.

The present disclosure provides a technical solution to a technical problem of requiring housing applicants to self-identify their gender. The roommate-comfort prompt 105 avoids making an applicant self-identify their gender and instead focuses the inquiry on the applicant's comfort with a roommate. This serves to resolve many of the problems with current systems at least because housing authorities are able to identify individuals who are comfortable rooming with trans or nonbinary people. By identifying trans allies in this manner, the system for providing housing assignments is improved because it is more accurate and efficient. This is true at least because fewer rehousing requests will result from implementation of the presently disclosed systems and methods. Rehousing requests tend to be burdensome, costly, and time-consuming, requiring significant resources to accommodate them. The present disclosure operates to reduce the instances of such requests, improving the housing assignment system overall.

In an embodiment of the present disclosure, a computer-implemented method for generating a housing application module and data is provided and comprises the following steps of: (1) receiving a request for a housing application from an applicant 110; (2) generating a housing application module in response to the request 120; (3) transmitting the housing application module to the applicant 130; (4) transmitting a roommate-comfort prompt 105 to the applicant 140; (5) receiving completed housing application data from the applicant 150; and (6) prioritizing the roommate-comfort prompt 105 response data over other application data 160. This method ensures that housing assignments will comply with applicant preferences and allow for safe and comfortable housing assignments. It will also reduce the number of gender-related rehousing requests.

In an embodiment, the housing server 100 receives a housing application request from an applicant 110, and generates a housing application module 120. The housing application module can be created or generated and stored before the request is made. The housing server 100 then transmits a housing application module to the applicant 130. The housing application module contains entry fields for a plurality of personal data, including, but not limited to, an applicant's name, physical address, email address, birth date, health history, disability information, country of origin, race, religion, etc. It also includes entry fields relating to dorm room preferences, including, for example, a list of preferred dorms. The housing application module may contain any number of fields so that the applicant can enter information that is useful to making the correct, appropriate housing assignment.

In an embodiment, after transmitting the housing application module to the applicant 130, the housing server 100 transmits the roommate-comfort prompt 105 to the applicant 140. As explained, the roommate-comfort prompt 105 asks applicants to confirm or deny that they are comfortable being roomed with a transgender or nonbinary person. The transmission 140 can occur while the applicant is accessing the electronic housing application form (i.e., the housing application module). The transmission 140 can be in the form of a pop-up that appears when the applicant enters information into the dorm-preference portion of the electronic housing application form. The transmission 140 can overlay the electronic housing application form, and remain in place until the applicant enters the requested information. The transmission 140 of the roommate-comfort prompt 105 can occur at any time, e.g., at the same time as or before the housing application is transmitted to the applicant at step 130. The transmission 140 can take on any form that is suitable for communicating the requested information, e.g., it can be part of the housing application module itself.

After reviewing and filling out the electronic housing form and the roommate-comfort prompt 105, the applicant returns the completed form (i.e., the housing application data) to the housing server 100 utilizing a communication device (e.g., a cell phone, laptop, tablet, personal computer, etc.). The housing server 100 determines if additional information is needed to complete the housing application form based on a form parameter associated with the housing application module (e.g., parent approval is a form parameter associated with applicants that are minors, doctor immunization records is a form parameter associated with student health care data, etc.).

The housing server 100 analyzes the completed application, including the applicant's response to the roommate-comfort prompt 105, and prioritizes the response of the latter in the determination of the housing assignment. The associated priority given to the roommate-comfort prompt 105 response is necessary to ensure that the correct assignment is made in light of all the applicant provided data. For instance, if the roommate-comfort prompt 105 were not given an associated priority, then it would not further the objective of ensuring that roommates were housed safely and comfortably with others aligned with their respective preferences.

According to the disclosure, the housing server 100 may be referred to as SAFE-THE, which is an acronym for Simple, Allyship, Failsafe, Equity, Transgender, Housing, Extension, though its name does not limit the present disclosure.

This disclosure is to be regarded as illustrative rather than restrictive. Although the inventive material in this disclosure has been described in detail along with some of its technical advantages, it will be understood that various changes, substitutions, and alterations may be made to the detailed embodiments without departing from the broader spirit and scope of the disclosure as set forth in the following claims. Many other embodiments will be apparent to those of ordinary skill in the art upon reading and understanding the above description. Although the present disclosure has been described with reference to specific embodiments, it is noted that the disclosure is not limited to the embodiments described or depicted herein. Rather, embodiments of the disclosure can be practiced with modification and alteration not herein mentioned, but otherwise within the spirit and scope of the claims herein provided.

What is claimed is:

1. A computer-implemented method for generating a housing application module for determining an applicant's roommate-comfort level and assigning housing accommodations, the method comprising:
receiving a request for a housing application from the applicant;
generating a housing application module in response to the request, wherein the housing application module includes requests for application data from the applicant;
transmitting the housing application module to the applicant, wherein said housing application module includes a roommate-comfort prompt to the applicant;
receiving completed housing application data from the applicant that includes a response to the roommate-comfort prompt;
prioritizing the roommate-comfort prompt response data over application data; and
generating a housing assignment that is consistent with the roommate-comfort response, thereby increasing accurate housing assignments and reducing the number of gender-related rehousing requests.

2. The method of claim 1, wherein the roommate-comfort prompt comprises a request for whether the applicant is comfortable rooming with a transgender person.

3. The method of claim 1, wherein the roommate-comfort prompt comprises a request for whether the applicant is comfortable rooming with a nonbinary person.

4. The method of claim 1, wherein the roommate-comfort prompt comprises a pop-up message that overlays the housing application module in a graphical user interface.

5. The method of claim 5, wherein the pup-up the roommate-comfort prompt comprises a pop-up message is programed to remain onscreen until the applicant enters a response.

6. The method of claim 1, wherein the roommate-comfort prompt comprises a request for a parent or guardian of the applicant provide a response.

7. A computer-readable medium having stored therein instructions for generating a housing application module for determining an applicant's roommate-comfort level and assigning housing accommodations being executable by a processor to perform operations, the operations comprising:
receiving a request for a housing application from the applicant;
generating a housing application module in response to the request, wherein the housing application module includes requests for application data from the applicant;
transmitting the housing application module to the applicant, wherein said housing application module includes a roommate-comfort prompt to the applicant;
receiving completed housing application data from the applicant that includes a response to the roommate-comfort prompt;
prioritizing the roommate-comfort prompt response data over application data; and generating a housing assignment that is consistent with the roommate-comfort response, thereby increasing accurate housing assignments and reducing the number of gender-related rehousing requests.

8. The computer-readable medium of claim 7, wherein the roommate-comfort prompt comprises a request for whether the applicant is comfortable rooming with a transgender person.

9. The computer-readable medium of claim 7, wherein the roommate-comfort prompt comprises a request for whether the applicant is comfortable rooming with a nonbinary person.

10. The computer-readable medium of claim 7, wherein the roommate-comfort prompt comprises a pop-up message that overlays the housing application module in a graphical user interface.

11. The computer-readable medium of claim 10, wherein the pup-up the roommate-comfort prompt comprises a pop-up message is programed to remain onscreen until the applicant enters a response.

12. The computer-readable medium of claim 7, wherein the roommate-comfort prompt comprises a request for a parent or guardian of the applicant provide a response.
